(19) United States
(12) Patent Application Publication
(10) Pub. No.: US 2006/0262032 A1
(43) Pub. Date: Nov. 23, 2006

(54) Controlled script thematic content sports restaurant system

(75) Inventor: Kenneth E. DeLine, Avon, CO (US)

Correspondence Address: CR MILES, P.C., 1 OLD TOWN SQUARE, SUITE 200 B, FORT COLLINS, CO, 80524, US

(73) Assignee: Holdings, LLC

(21) Appl. No.: 11/110,481

(22) Filed: Apr. 20, 2005

(51) Int. Cl. G09G 5/00

(52) U.S. Cl. 345/1.1

(57) ABSTRACT

A sports theme restaurant which controls substantially the entirety of the thematic content perceived by restaurant patrons to build brand identity in particular sports teams or players.

### I. BACKGROUND

Generally, a restaurant which controls scripted thematic content perceived by restaurant patrons to generate brand identity in the restaurant, shareholders, or clients. Specifically, a sports theme restaurant which controls scripted thematic content perceived by restaurant patrons to generate brand identity in the sports theme restaurant, sports teams, or sports players.

Sporting activity brings fans together collectively for the enjoyment of the sports team, the sports players, and the camaraderie of sharing the sporting event. It allows the diversity of a community to come together to rally behind a symbol called the Bobcats sports team or the Sting sports team. Through association with the sports team or a sports player the community can build a regional asset in the brand identity of the regional sports team or in the brand identity of the regional sports player, or both. The brand identity in the regional sports team or the brand identity in the regional sports player adds greater value to the entire region. Not just the downtown region, but also the suburban regions, as fans feel there's a reason to want to be part of the downtown region.

Regional brand identity in the sports team or the brand identity in the individual sports player can be important because the brand acts to build interest in the survivability of the regional community, and brings fans together for the sporting events and to engage in other activities which further develops the regional community and promotes regional businesses. Branding also enables regional sports teams and regional sports players to manage the public perception of their common and individual sports business in the regional community. By promoting a unique niche that sets the sports team or the sports player apart from other sports teams and sports players, fans are better able to distinguish one sports team or one sports player from another. These distinctions make it easier for a prospective fan to identify a sports team or sports player from the start. When a prospective fan can readily identify with the sports team or the sports player, it is easier for the sports team or for the sports player to achieve fan satisfaction.

However, even though sports team branding and sports player branding are well known concepts, existing practices of operating sports businesses can create significant problems in effectively establishing and maintaining the brand identity of sports teams and the brand identity of sports players.

One significant problem in establishing and maintaining sports team and sports player brand identity can be the high turnover of sports players from regional sports team to regional sports team. It comes as no surprise that sports teams are businesses and sports team owners and sports players want to make money. If you are going to generate fans by tying a sports team to a region or locality, locating sports teams in larger markets will generate more fans and more revenue for owners.

This logic can be extended to the specific revenue difference generated by a single additional win in a season. Teams in larger cities have a greater pool of fans to enjoy wins; therefore, wins are more valuable to big market teams. While an extra win per season in Kansas City may generate 10,000 more fans, the same extra win per season in New York City may generate a million more fans along with the corresponding additional revenue. Because fans generally prefer to watch winning teams, and because of the strong economic incentive to win additional games, owners seek out the best players which can generate additional wins and bring in increased revenue.

In an open market for players, larger market sports teams have an advantage over smaller market sports teams in attracting good players because they can offer higher salaries; thus larger market sports teams can translate the big city advantage into wins on the field by purchasing better players. This result is strongly supported in the economics literature. See for example, “An Economic Model of a Professional Sports League” by Mohamed El-Hodiri and James Quirk (1971). As a result, the turnover rate for sports players among sports teams has dramatically increased. For example, the turnover rate for hitters in major league baseball now hovers at near thirty percent. Importantly, the increasing player turnover rate in sports teams makes it difficult for sports teams and sports players from presenting and promoting a consistent regional brand identity which is a key component to any successful marketing strategy whether for a sports team as a whole or for an individual player.

Unfortunately, the popular solutions to limit the big market advantage can actually operate to increase player turnover and impair regional brand identity and player brand identity. For example, revenue sharing by which a portion of local revenues (typically between 20 and 50 percent) are shared between all sports teams in a particular league to assist the weaker sports teams may actually create a disincentive to winning and increase player turnover. In fact, revenue sharing has a greater deterrent effect on poorly performing teams than on teams that perform well. Any sports team would be reluctant to increase its payroll unless it thought the increase in payroll could substantially increase local revenues. While this may be relatively easy for contenders, for whom a better team means higher attendance, for a poorly performing team increasing its payroll to gain a few additional wins may be a terrible investment. The result may be that smaller market teams use lesser known home grown players and bargin free agents to fill the roster which only serves to make the team less competitive, less desirable to fans, and further impairs the regional brand identity of the sports team and the brand identity of the sports players.

Another popular solution advocated to limit the big market advantage is an annual competitive-balance draft, in which the clubs with the worst records select from a group of players belonging to the best playoff teams, but who are not on or eligible for their roster. While this approach may operate to provide additional competitive balance between the various sports teams which fans desire, it exacerbates the problem of player turnover and again works to reduce brand identity of the regional sports team and the brand identity of the sports player.

Another approach to inhibit player turnover is spending caps in which team owners agree not to spend more than a certain, pre-determined amount on payrolls, often less than some franchises already dole out. Some sports already have some sort of cap on individual player salaries, but these are typically set up with a number of exemptions and exceptions to get around the rule. For example, the National Hockey League limits the salary of rookies and players under a certain age but doesn't restrict performance bonuses to them. The National Basketball Association also has individual salary limits in place but there are so many ways to work around salary limits that they are rarely a factor. The net effect of the types of caps currently in use is to put more money in the hands of owners and less in the hands of the players.

In any event, it appears the level of player turnover will remain high due to free agency of players, the monetary incentive to obtain the best players for the largest markets, and as a result of the methods employed to maintain the competitiveness between sports teams. Correspondingly, there will be an increased problem with regard to establishing and maintaining the necessary or desired level of regional brand identity in regional sports teams or in regional sports players.

Another significant problem in establishing and maintaining sports team brand identity and sports player brand identity can be the high cost and lack of effectiveness of traditional methods of branding teams and branding players. For example, using a marketing campaign that may be one of the most costly in National Basketball Association history, the Clippers® have added player branding to their traditional retail advertising campaign. The campaign, centered on the team's new players comprises almost daily ads in the Los Angeles Times starting shortly after Labor Day. “Hi, I'm Player Miles,” one ad starts out. Players go on to talk about where they're from, what they hope to accomplish, why they want to play for the Clippers®. Unfortunately, these traditional approaches to branding players do not appear to work. In following up with Clippers fans it is clear that retail advertising in print does not generate brand identity in view of high player turnover rates. As one fan indicated “I've been following the campaign in the paper for the last week or so,” . . . “but why should I care?” . . . “Not to be disrespectful of them, but why would I want to invest my energy or emotion into a team when turnover is traditionally high?”

Another significant problem in establishing and maintaining sports team brand identity and sports player brand identity can be the control of the content used to promote branding of sports teams and sports players. Often content exists as a combination of paper documents, such as magazines and newspapers, distributed manually. Paper documents are a burden to store, even more difficult to share widely, and can quickly become outdated and thus unreliable. Electronic content reduces the storage and distribution problem, but as electronic content circulates it may be revised, resulting in different versions in use. Whether involving paper documents or electronic content, poor control results in a host of problems such as incorrect or out-of-date information, increased review and approval cycles, or poor document tracking all of which impair brand identity. Without the ability to control content concerning sports teams and sports players, the information contained within it is lost, and a valuable asset is wasted, or may be positively harmful—for financial, legal, or competitive reasons. Establishing and maintaining the brand identity of sports teams which generate fans by tying a sports team to a region or locality while the sports teams and the sports players relocate from region to region requires a level of information processing and scripting that must be carefully managed in the same way that physical assets and production processes have been managed in an industrial economy.

Another significant problem in establishing and maintaining sports team brand identity and sports player brand identity can be the lack of consistent regional portals which control content relating the regional sports teams or regional sports players sufficiently to generate brand identification by the fans. Fans continue to rely largely upon watching conventional television programming or in person game attendance to obtain information about the regional sports team or players. For regional teams that are not contenders the paucity of information and low fan attendance at games can be insufficient to brand the sports team or the sports team players to build or maintain interest in the regional community.

This problem includes the lack of restaurants, whether sports theme restaurants, or other types of theme restaurants, which control thematic content perceivable by restaurant patrons sufficiently to achieve brand identification of the restaurant in the controlled content, the regional sports teams, or the regional sports players. While conventional restaurants zealously expend resources on controlling the physical appearance of the restaurant or a plurality of restaurants to achieve identity or chain restaurant identity with restaurant patrons, it has been entirely overlooked that a restaurant can achieve brand identity in the affirmative control of the information content broadcast or perceivable to restaurant patrons within the restaurant. This is particularly true of sports restaurants in which unedited televised broadcast typically provides the entirety of the information perceivable by restaurant patrons relating to the sports restaurant, the regional sports team, regional sports players, and advertised products regardless of the branding power of the content as to each, and which in some instances can actually be harmful to brand identity rather than beneficial.

In part this problem may be due to a lack of content valuation means which can be used by the restaurant ownership to value content prior to perception by the restaurant patrons. One aspect of this problem may be the lack of valuation metrics for restaurant thematic content or failure to include certain valuation factors in the valuation metrics for restaurant thematic content. A second aspect of this problem can be the failure to establish threshold values for thematic content to achieve brand identity for the restaurant in the controlled thematic content, or in particular, the sports theme restaurant, or the regional sports team or sports player. Another aspect of this problem can be the failure to couple value identifiers to discrete thematic segments of content so that a plurality of discrete thematic segments of information content can be sorted or retrieved based upon the value established by valuation metrics to meet or exceed, whether individually or in various combinations or permutations, particular threshold valuations.

As to each of these problems in establishing and maintaining a brand identity for sports teams and sports players, the instant controlled scripted thematic content restaurant system provides a solution.

### II. SUMMARY OF THE INVENTION

Accordingly, broad object of the restaurant invention can be to provide a restaurant business in which the ownership controls or substantially controls the entirety of the thematic content perceived by the restaurant patrons.

Another broad object of the restaurant invention can be to provide a restaurant branded by provision of controlled information content as a restaurant service. One aspect of this object of the invention can be restaurant ownership control of a sufficient amount of information perceivable by the restaurant patron to achieve brand identification in the restaurant as a provider of controlled information content. Another aspect of this object of the invention can be to script content perceivable to the restaurant patron to an extent that there is brand identification in the restaurant as providing scripted controlled content. Another aspect of this object of the invention can be to co-brand other products to an extent that there is brand identification between the manner of co-branding such other products and the restaurant itself.

Another broad object of the restaurant invention can be to provide a script generation element in which a plurality of discrete thematic segments can be positioned in serial or in parallel in a plurality of durational periods of one or more scripts to be transmitted to the dining area of the restaurant for perception by restaurant patrons.

Another broad object of the invention can be to provide identifiers coupled to each of a plurality of discrete thematic segments which allow the plurality of discrete thematic segments to be sorted by a variety of parameters by which discrete thematic segments can be combined into scripts or allow the plurality of discrete thematic segments to be sorted by valuation identifiers by which valuation threshold(s) can be met or exceeded to satisfy agreements with clients or generate brand identity in the restaurant itself or in restaurant shareholders, or in restaurant clients such as regional sports teams or regional sports players.

Another broad object of the restaurant invention can be to provide a sports theme restaurant which utilizes controlled scripted thematic content perceivable to the restaurant patrons of the restaurant business to build brand identity in sports teams and sports players.

Another broad object of the restaurant invention can be to provide a restaurant business having a plurality of investment regions which allows transfer of controlled scripted thematic content identifiable to a sports team or a sport player between a first investment region and a second investment region when the sports team or sports player transfers from the first investment region to a second investment region.

Naturally, additional objects of the restaurant invention are disclosed by the description and figures.

### III. A BRIEF DESCRIPTION OF THE DRAWINGS

FIG. 1 is a front end view perspective of a building which provides enclosed space for an embodiment of the controlled content restaurant invention.

FIG. 2 is a floor plan of an embodiment of the restaurant invention in the enclosed space provided by the building shown by FIG. 1.

FIG. 3 is a perspective view of an embodiment of restaurant invention in the enclosed space provided by the building shown by FIG. 1.

FIG. 4 is a block diagram of computer which includes an embodiment of the script generation element which utilizes discrete thematic segments stored in a memory element to generate scripted thematic content perceivable by restaurant patrons in the dining area of an embodiment of the restaurant invention.

FIG. 5 shows an embodiment of the restaurant invention which provides a plurality of investment regions in which a plurality of sports teams or sports players can own a portion of the plurality of shares in which the restaurant ownership is divided.

FIG. 6 is a block diagram of an embodiment of the invention which provides a plurality of investment regions each of which allocates a portion of a plurality of shares among a plurality of regional sports or regional players in which sports teams and sports players can invest.

### IV. DETAILED DESCRIPTION OF THE PREFERRED EMBODIMENTS

Generally, a restaurant which controls the information content perceived by restaurant patrons to develop brand identity in the restaurant, other businesses, persons, and products. Specifically, a sports theme restaurant which controls the thematic sports content perceived by restaurant patrons to develop brand identity in the sports theme restaurant, particular sports teams, players, or products.

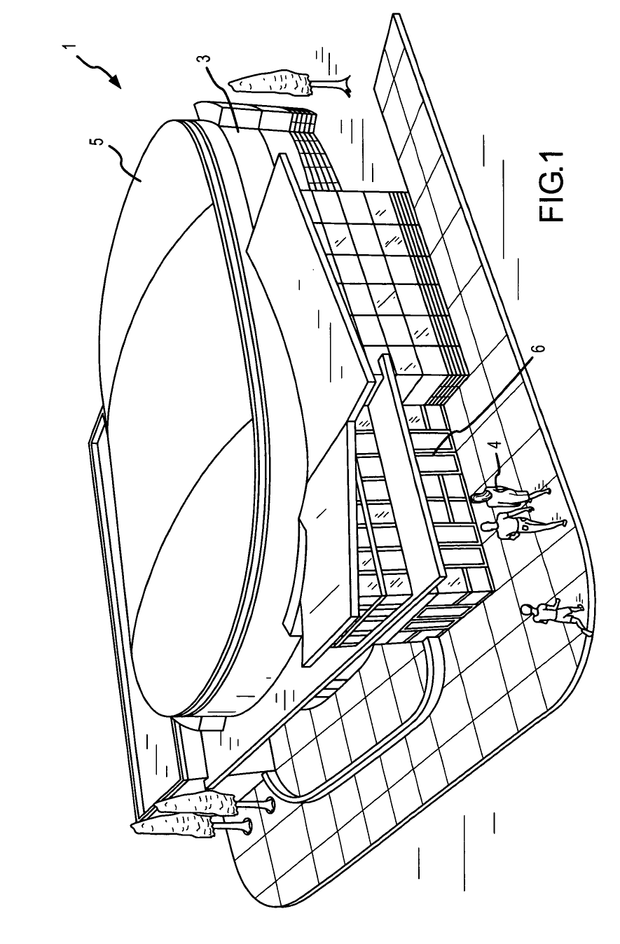

Now referring primarily to FIG. 1, the controlled content restaurant invention includes a building (1) which provides an enclosed space (2). The term “building” generically encompasses any structure capable of providing an enclosed space (2) for the provision of restaurant services. The exterior structure (3) of the building (1) does not have to afford any particular style of architecture, although the exterior structure (3) can be configured to convey a theme to restaurant patrons (4). For example, a particular non-limiting configuration of the exterior structure (3) of the building (1) which can be utilized to convey a sports theme to restaurant patrons can be the use of architectural elements which provide the appearance of a sports arena.

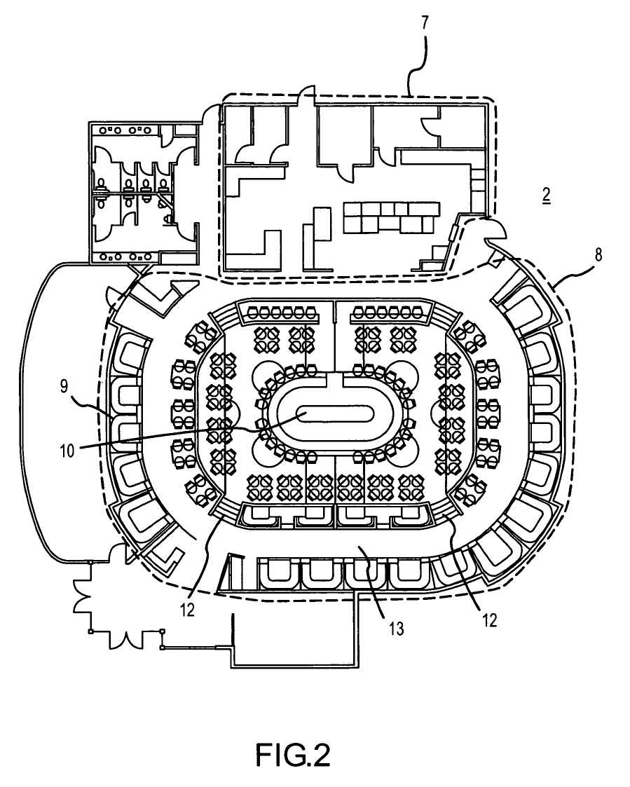

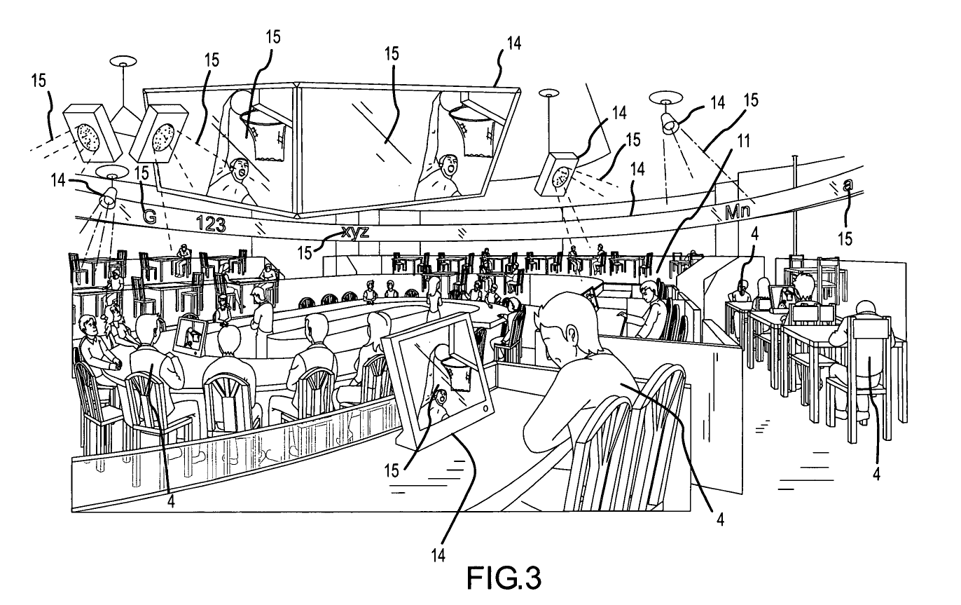

As to this particular embodiment of the invention, the architectural elements may include, for example, an oval, round, or rectangular oval configuration (5) of the exterior structure (3) of the building (1) which can be carried through to the interior enclosed space (2), as shown by FIGS. 2 and 3. An arena like entry (6) can be connected to the rectangular oval configuration (5) having sufficient vertical height to provide the appearance of access to a plurality of tiers within the interior enclosed space (2). Naturally, a variety of other architectural elements could be included to the exterior structure (3) of the building (1) to convey the appearance of a sports arena to restaurant patrons (4) consistent with a particular sport such as football, baseball, ice hockey, basketball, or the like. However, this example is not intended to be limiting with respect to the exterior structure (3) of the building (1) or the exterior architectural elements of the building (1) which can be configured to convey numerous and varied restaurant themes to restaurant patrons (4).

Now referring primarily to FIGS. 2 and 3, a kitchen area (7) which prepares food can be located within a first portion of the enclosed space (2). A dining area (8) in which restaurant patrons (4) are served food prepared in the kitchen area (7) can be located within a second portion of the enclosed space (2). Naturally other portions of the enclosed space can provide other facilities such as restrooms, game rooms, a foyer, or the like. As with the exterior of the building (1), the restaurant theme can be carried into the enclosed space (2).

Again using the non-limiting example of the sports theme restaurant above-described, the interior enclosed space (2) can be configured to afford a rectangular oval enclosed space (9) typically of sports arenas. A central square, round, oval, or rectangular oval floor space (10) can be configured to convey the appearance of a hard court or ice rink within a sports arena. The arena sports theme can be further built upon by configuring the enclosed space (2) surrounding the central rectangular oval floor space (10) to further include a plurality of rectangular oval tiers (11). Each of the plurality of rectangular oval tiers (11) can provide seating area established at a discrete level above the central rectangular floor space (10)(or other reference level). One or more stairways (12) can communicate with the rectangular oval tiers (11) to provide a service pathway to the dining areas (8) established on each rectangular oval tier (11). The service pathway can further include a concourse (13) established on one or more of the rectangular oval tiers (11). Again this non-limiting example of configuring the enclosed space (2) of the building (1) in sports arena like architecture is intended to be illustrative of the numerous and wide variety of themes, whether sports theme or otherwise, that can be developed in the enclosed space (2) of a building (1) which can be marketed to restaurant patrons (4).

Now referring primarily to FIG. 3, the enclosed space (2) in the building (1) can further provide a thematic content delivery means (14) capable of providing perceivable thematic content (15) (as further described below) to restaurant patrons (4). The thematic content delivery means (14) can include a wide variety of visual display devices and media server software display devices including without limitation: flat panel displays, liquid crystal displays, cathode ray tubes, plasma display, high definition flat panel displays, touch screen displays, 3D displays, wide screen displays, light emitting diode displays, matrix lamp displays, Jumbo-trons®, projectors and projection screen, compact disc players, video disc players, media servers such as the Catalyst® Pro, or the like. The thematic content delivery means (14) can further or in the alternative include audio generation devices comprising without limitation: loudspeakers, wireless audio, speakers combined with a visual display whether separate or integral, headphones, home theater, or the like. The thematic content delivery means (14) can further or in the alternative include lighting devices comprising without limitation: conventional lighting fixtures, digital lighting fixtures, spot lights, light emitting diodes, or the like. As to each of the numerous and varied thematic content delivery means (14) capable of providing perceivable thematic content (15) to restaurant patrons (4) the necessary power and transmission hardware means and circuitry means can be further provided as would be known to a person of ordinary skill in the art.

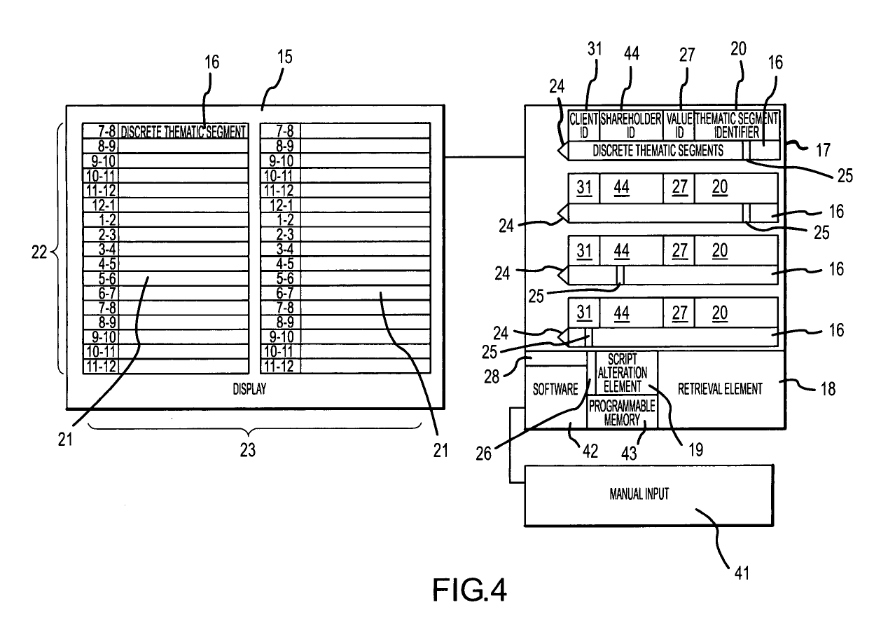

Now referring primarily to FIG. 4, the thematic content (15) perceivable (whether by seeing, hearing, or feeling, or in various combinations and permutations thereof) by restaurant patrons (4) can further include a controlled scripted thematic content. As to control of the thematic content (15) by the ownership of the restaurant (30) can be established through independent development of the thematic content; the purchase or assignment of the thematic content from the owner of the thematic content; or by license, lease, or consent by the owner of the thematic content; or otherwise, which provides the restaurant ownership with sufficient rights in and to the thematic content to script the thematic content prior to perception by the restaurant patrons (4).

As to scripting of the thematic content to provide scripted thematic content, this can generically encompasses any affirmative action by the restaurant ownership to isolate thematic content into discrete thematic segments (16). Discrete thematic segments (16) can be delivered separately or in various combinations or permutations for perception by restaurant patrons (4). Discrete thematic segments (16) are of adjustable duration, variably adjustable duration as controlled by the restaurant ownership. The information content (whether visual images, audio sound, or otherwise) of discrete thematic segments (16) can altered, to include additional content, delete a portion of the content, or otherwise alter the thematic content perceived by the restaurant patron (4). The discrete thematic content (16) can include content or data relating to the restaurant, another business entity such as a sports team, or a person such as a shareholder in the restaurant or a sports player, or a product such as a sports product. The content can be in analog or digital format or converted from analog to digital format for storage and retrieval. The content can be produced to establish, develop, generate, build, maintain, alter, or otherwise act upon the restaurant patron (4) while dining to brand a business, person, or product. Specifically, with respect to businesses (such as sports teams) which are tied to a region but have product turnover (such as sports player turnover) the discrete thematic content can include information on the product(s) or sports player(s) which can be sufficient in itself or in combination with a plurality of discrete thematic segments to build brand identity in the business, product, sports team, or sports player with restaurant patrons (4). Importantly, this restaurant service provided to restaurant patrons (4) can act to build brand identity in the restaurant itself.

As shown by FIG. 4, the discrete thematic segments (16) can be stored in a memory element (17) of a computer (40) having a user interface (41). A software program (42) can in part include a script generation element (19) which can further include a programmable memory (43) to which a thematic segment retrieval element (18) responds to retrieve one, a portion of or all of the discrete thematic segments (16) stored in the memory element (17) for transmission to the thematic content delivery means (14) for perception by the restaurant patrons (4). Each discrete thematic segment (16) can further include a thematic segment identifier (20) responsive to the thematic segment retrieval element (18) for selective retrieval of discrete thematic segments (16) based on the thematic segment identifier. The script generation element (19) can further provide a plurality of adjustable durational periods (22) in which discrete thematic segments (16) can be positioned in the script (21) either in serial order or positioned in a plurality of scripts (23) in parallel order. The positioning of discrete thematic segments (16) in the adjustable durational periods (22) allows generation of scripted thematic content which can be continuous or discontinuous (having intervals between transmission of discrete thematic segments (16) to the thematic content delivery means (14)), as necessary, desired, or consistent with the scripting procedure or policy of the ownership of the restaurant (30) or central investment entity (39) or between investment regions (34), as further described below. While FIG. 4, illustrates an embodiment of the restaurant invention having durational periods each of one hour, this is not intended to be limiting with respect to numerous and varied embodiments of the invention which can provide adjustable durational periods of any desired, required, or necessary unit of duration such as milliseconds, seconds, minutes, hours, or combinations or permutations thereof in which discrete thematic segments (16), or portions thereof, can be positioned.

Each discrete thematic segment can further include a serial alignment identifier (24) which can operate to dovetail the plurality of discrete thematic segments (16) retrieved by the thematic segment retrieval element (18) into a single integral piece of thematic content based on the script (21). Similarly, each discrete thematic segment (16) can further include a parallel alignment identifier (25) which can operate to align the discrete thematic segments (16) in parallel in a single script (21) or between a plurality of scripts (23).

The script generation element (19) can further include a script valuation element (26) which allows the restaurant ownership to sort a plurality of discrete thematic segments by a value identifier (27) coupled to each of the discrete thematic segments (16). The value identifier (27) which can be coupled to each of the plurality of discrete thematic segments (16) can be the output from any manner of standardized valuation metrics (28) applied by the restaurant ownership to value independently or in various combinations or permutations individual factors such as the duration of the discrete thematic segment (16), the calendar date, the time period in the calendar date, the time period in the script (21), the position in the script (21), the number of times the discrete thematic content (16) has been retrieved in a duration of time, the thematic content, the client, the production cost, the delivery cost, the amount of revenue generated by the discrete thematic content (16) per transmission, the branding power of the discrete thematic segment (16)(whether to the restaurant, the shareholder, or a client), various events internal to the restaurant such as restaurant service periods including breakfast, lunch, dinner, happy hour, pre-game, post-game, or the like, various events external to the restaurant such as the date of a particular sporting event, the sports teams involved in a particular sporting event, the type of sporting event, the start time or end time of the sporting event, whether the regional sports team won or lost the sporting event, or the like.

The value identifier (27) once coupled to each of the plurality of discrete thematic segments (16) can as to some embodiments of the invention remain fixed or as to other embodiments of the invention variably adjust as the values of individual factors in the valuation metrics (28) vary. As but one example, the script valuation element (26) can utilize the value identifiers (27) coupled to the plurality of discrete thematic segments (16) to generate a script (21) or assist in generating a script (21) having a desired valuation in or for a particular restaurant service period in the context of the various events whether internal or external to the restaurant. In another non-limiting example, the script valuation element (26) can utilize the value identifiers (27) coupled to the plurality of discrete thematic segments (16) in a particular script (21) to generate an estimate of restaurant revenue utilizing that particular script (21). A further example of using the script valuation element (26) can be to utilize the value identifiers (27) to establish a script (21) which generates a level of branding power for a particular sports team or sports player. In each of the examples, the restaurant ownership (30) can utilize the script valuation element (26) to alter the script (21) to obtain a desired threshold valuation as to restaurant patron entertainment, restaurant revenue generation, or branding power, or other parameter of a script (21) prior to delivery of the script (21) to the thematic content delivery means (14) for perception by restaurant patrons (4).

In certain embodiments of the restaurant invention, standardized valuation metrics (28) can be an adjustable standardized valuation metrics or a plurality of standardized valuation metrics which correspond to an adjustable valuation identifier (27) or a plurality of valuation identifiers (27). For example, the mark Coke® has nearly 100% brand awareness. Discrete thematic segments (16) which further promote brand awareness in Coke® may have low value and the coupled value identifiers (27) may be adjusted to avoid selection of discrete thematic segments (16) which would further promote brand awareness. Alternately, promotion of Coke® brand favorability or purchase intent may have high value and the coupled value identifiers (27) may be adjusted to allow selection of discrete thematic segments (16) established by valuation metrics (28) which emphasize favorability or purchase intent. The particular above-described embodiment of the invention which utilizes computer hardware and computer software to provide a script generation element which operates to sort and position digitized discrete thematic segments (16) utilizing various identifiers and valuation elements to generate scripts (21) transmittable to the thematic content delivery means (14) is not intended to be limiting with respect to the wide variety of computer networks, computers, computer displays, memory devices, software programs whether stock software programs or custom software programs, retrieval means, or script generation means, analog to digital converters, data transmission means, or the like which can be utilized in accordance with the invention, but rather is sufficiently illustrative to allow a person of ordinary skill in the art to make and use the restaurant invention whether solely through the use of stored digitized data retrievable and scripted by computer hardware and computer software as above-described or in part or whole through manual data and information handling which results in the same or similar elements or functions.

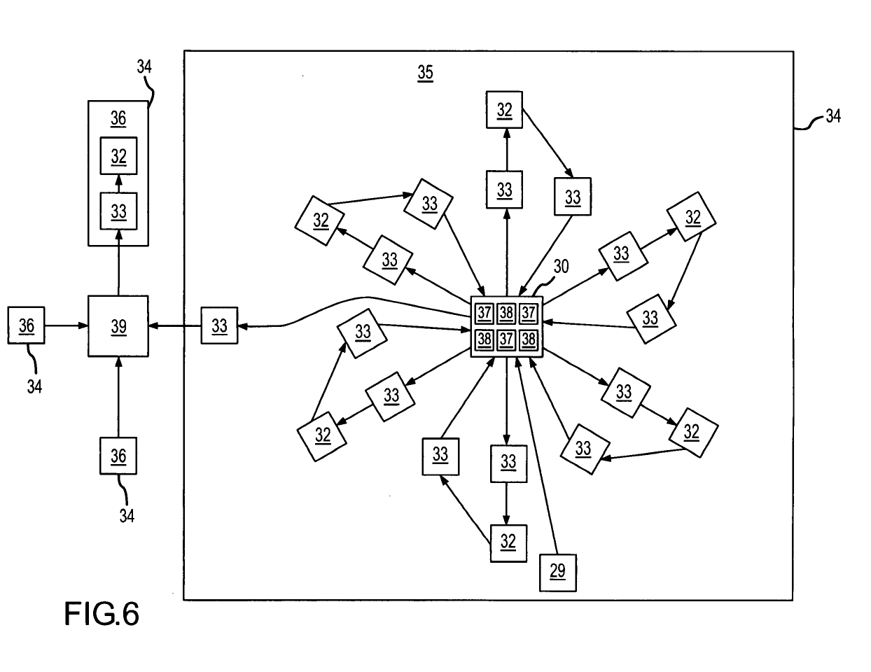

In other embodiments of the restaurant invention, a client (29) (as shown by FIG. 6) can pay the restaurant ownership (30) to transmit particular scripts (21) to the thematic content delivery means (14) to be perceived by restaurant patrons (4). The client(s) (29), for example, can be a sports team including professional sports teams, or non-professional university or college sports teams, or local school teams; or the like. The sports teams can include without limitation: ice hockey teams, baseball teams, football teams, arena football teams, soccer teams, volleyball teams, tennis teams, basketball teams, bicycling teams, automotive racing team, or the like. The client (29) can be an individual player associated with a sports team, and either the sports team or the individual sport's team player can pay the restaurant to transmit particular scripted thematic segments to be perceived by restaurant patrons (4). Alternately, the client (29) can be an individual sportsman whether professional or amateur associated with a sport such as fishing, bowling, climbing, tennis, or the like, which pays the restaurant to transmit a particular script (21) of discrete thematic segments (16) to be perceived by restaurant patrons (4). In any event, the term “client” is intended to broadly encompass any business entity or person not a restaurant owner that pays the restaurant ownership (30) to include in the script (21) perceived by restaurant patrons (4) certain discrete thematic segments (16).

As to these embodiments of the restaurant invention the discrete thematic segments (16) can further include a client identifier (31) which allows the plurality of discrete thematic segments (16) stored in the memory element (17) to be sorted by client (29), in addition to the other identifiers above-described, to include in a script (21) discrete thematic segments (16) identifiable with the client (29) to be perceived by restaurant patrons (4) to build brand identity in the client (29), as above described.

Now referring primarily to FIGS. 4-6, the restaurant ownership (30) can be divided among a plurality of shareholders (32) each of which receive a portion of a plurality of shares (33). The plurality of shareholders (32) can comprise without limitation a sports team, a player on a sports team, an individual sport player, or other business entity or person. An amount of scripted thematic content or discrete thematic segments (16) can be identified with each of the plurality of shareholders (32) by further coupling a shareholder identifier (44) to the corresponding portion of the plurality of discrete thematic segments (16). The plurality of discrete thematic segments (16) stored in the memory element (17) can the be sorted based on each of the plurality of shareholders (32) by operation of the script generation element (19). The plurality of discrete thematic segments (16) sorted based on the shareholder identifier (33) can be retrieved from the memory element (17) and positioned in the script (21), as above-discussed, and transmitted to the thematic content delivery means (14) for perception by the restaurant patrons (4).

The amount of scripted thematic content perceivable to the restaurant patrons (4) as to each of the plurality of shareholders (32) can be based on, or based in part on, the portion of the plurality of shares (33) in held by each of the plurality of shareholders (32) in the restaurant business (1). The valuation metrics (28) discussed above can further include factors to establish a value in the portion of the plurality of shares (33) held by each of the plurality of shareholders (32), a value in the branding power of a particular script to each of the plurality of shareholders (32), a value in the particular script to the restaurant ownership (30), which may be weighted to establish the amount of scripted thematic content of each of the plurality of shareholders (32) perceivable by the restaurant patrons (4).

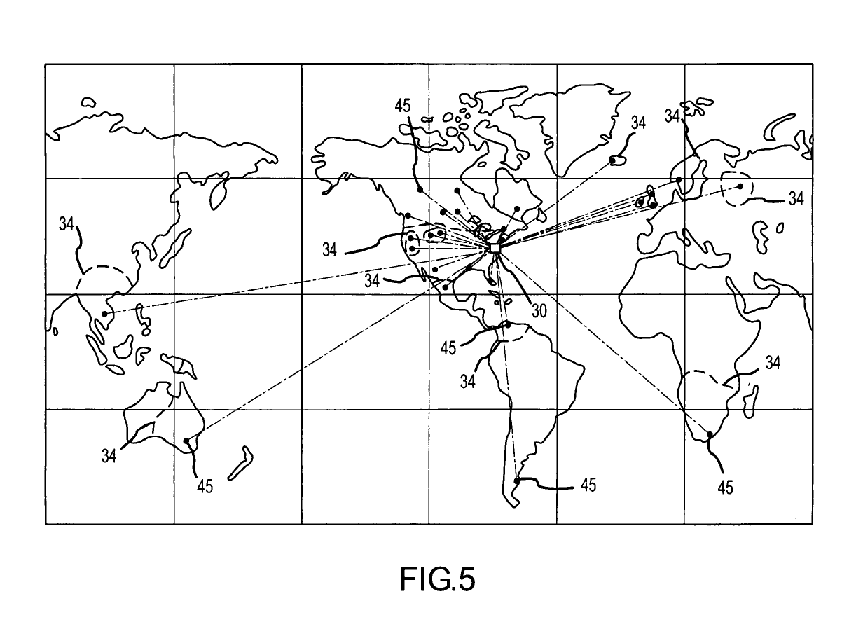

Now referring primarily to FIGS. 5 and 6, the restaurant invention can further include a plurality of investment regions (34). The each of the plurality of investment regions (34) may correspond to geographic regions in which regional sports teams or regional sports players are located or reside. As such, each of the plurality of investment regions (34) can vary in geographic configuration and can comprise a plurality of contiguous or discontiguous investment regions. In certain embodiments of the restaurant invention, each of the plurality of investment regions (34) can include the plurality of shares (32) into which the restaurant ownership (30) of the regional restaurant business is divided among a plurality of shareholders (32).

Each of the plurality of investment regions (34) can include one or a plurality of theme restaurants (45) or sports theme restaurants in accordance with the invention. Scripted thematic content controlled by the restaurant ownership (30) can transmit to each of the thematic content delivery means (14) in each theme restaurant (45) to be perceived by restaurant patrons (4). This approach generates a plurality of consistent regional portals through which scripted thematic content relating to the regional sports team(s) or regional sports players can be communicated to fans. If the regional sports team moves from a first investment region (35) to a second investment region (36) or a regional sports player is traded from a first investment region (35) to a second investment region (36), the corresponding portion of the plurality of shares (32) held by the sports team or sports player in the first investment region (35) can be transferred to the second investment region (36) through a single investment entity (39).

The discrete thematic segments (16) and scripted thematic content identifiable to that sports team or sports player in the first investment region (35) can also be transferred from the first investment region (35) to the second investment region (36)(although script generation and transmission can be occur from a single location). As such, the discrete thematic segments (16) and scripted thematic content transferred from the first investment region (35) to the second investment region (36) can be altered or scripted by the restaurant ownership (30) of the second investment region (36). In this manner the restaurant invention allows, regional sports teams and regional sports players to establish and maintain a first brand identity in a first investment region (35) for a first duration of time and in a second brand identity in a second investment region (36) for a second duration of time without divesting ownership or the portion of the plurality of shares (32) in the restaurant business.

Now referring primarily to FIG. 7, the percentage ownership (45) in each of the plurality of investment regions (34) can be prior allocated between a plurality of regional sports teams (37) to maintain a desired balance in the amount of scripted thematic content of each of the plurality of regional sports teams (37) perceived by restaurant patrons (4). Similarly, the percentage ownership in each of the plurality of investment regions (34) can be prior allocated between a plurality of regional sports players (38) to maintain a desired balance in the amount of scripted thematic content of each of each of the plurality of regional players (38) perceived by the restaurant patrons (4).

As can be easily understood from the foregoing, the basic concepts of the present invention may be embodied in a variety of ways. The invention involves numerous and varied embodiments of a controlled content restaurant and methods of making and using such controlled content restaurant.

As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “elevator” should be understood to encompass disclosure of the act of “elevating”—whether explicitly discussed or not—and, conversely, were there effectively disclosure of the act of “elevating”, such a disclosure should be understood to encompass disclosure of a “elevator” and even a “means for elevating.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the controlled content restaurants herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A restaurant, comprising:
a. a building which provides an enclosed space;
b. a kitchen area located within a first portion of said enclosed space which prepares a food;
c. a dining area located within a second portion of said enclosed space in which restaurant patrons are served said food prepared in said kitchen area;
d. a scripted thematic content perceivable by said restaurant patrons in said dining area of said restaurant; and
e. an ownership in said restaurant which controls substantially all of said scripted thematic content perceivable by said restaurant patrons.

2. A restaurant as described in claim 1, further comprising a plurality of discrete thematic segments which comprise said scripted thematic content perceivable by said restaurant patrons in said dining area of said restaurant.

3. A restaurant as described in claim 2, wherein said plurality of discrete thematic segments are stored in a memory element

4. A restaurant as described in claim 3, further comprising a script generation means which operates to selectively retrieve a portion of said plurality of discrete thematic segments stored in said memory element.

5. A restaurant as described in claim 4, further comprising a thematic segment identifier coupled to each of said plurality of discrete thematic segments responsive to said script generation means.

6. A restaurant as described in claim 5, further comprising a shareholder identifier coupled to at least one of said plurality of discrete thematic segments responsive to said script generation means.

7. A restaurant as described in claim 6, further comprising a client identifier coupled to at least one of said plurality of discrete thematic segments responsive to said script generation means.

8. A restaurant as described in claim 7, wherein said thematic segment identifier allows said plurality of said discrete thematic segments stored in said memory element to be sorted by said script generation means based on said thematic segment identifier.

9. A restaurant as described in claim 8, wherein said shareholder identifier allows said plurality of said discrete thematic segments stored in said memory to be sorted by said script generation means based on said shareholder identifier.

10. A restaurant as described in claim 9, further comprising a plurality of shares into which said ownership of said restaurant is divided.

11. A restaurant as described in claim 10, wherein said ownership of said restaurant alters said scripted thematic content perceivable by said restaurant patrons in said dining area of said restaurant to build brand identity in a shareholder.

12. A restaurant as described in claim 11, wherein said shareholder comprises a sports team.

13. A restaurant as described in claim 12, wherein said shareholder comprises a sports player.

14. A restaurant as described in claim 13, wherein said client identifier allows said plurality of said discrete thematic segments stored in said memory to be sorted by said script generation means based on said client identifier.

15. A restaurant as described in claim 14, further comprising a client which pays said ownership in said restaurant to alter said scripted thematic content perceivable by said restaurant patrons.

16. A restaurant as described in claim 15, further comprising a value identifier coupled to at least one of said plurality of said discrete thematic segments responsive to said script generation means.

17. A restaurant as described in claim 16, wherein said value identifier allows said plurality of said discrete thematic segments stored in said memory element to be sorted by said script generation element based on said value identifier.

18. A restaurant as described in claim 17, wherein said value identifier coupled to said at least one of said plurality of said discrete thematic segments corresponds to an amount of revenue generated by said at least one of said plurality of said discrete thematic segments in said scripted thematic content perceivable by said restaurant patrons.

19. A restaurant as described in claim 18, wherein said script generation means further comprises a plurality of adjustable durational periods to position each of said plurality of discrete thematic segments in said scripted thematic content perceivable by said restaurant patrons in said dining area of said restaurant

20. A restaurant as described in claim 19, further comprising a serial alignment identifier within each of said plurality of discrete thematic segments to align said plurality of discrete thematic segments serially in said adjustable durational periods of said script generation means.

21. A restaurant as described in claim 20, further comprising a parallel alignment identifier within each of said plurality of discrete thematic segments to align said plurality of discrete thematic segments in parallel in said adjustable durational periods of said script generation means.

22. A restaurant as described in claim 21, wherein said ownership in said restaurant alters said scripted thematic content to adjust said amount of revenue received by said restaurant.

23. A restaurant as described in claim 22, wherein said amount of revenue received by said restaurant comprises a payment to said ownership in said restaurant by said client to alter said scripted thematic content perceivable by said restaurant patrons.

24. A restaurant as described in claim 23, wherein said ownership in said restaurant alters said scripted thematic content perceivable by said restaurant patrons to build said brand identity in said client.

25. A restaurant as described in claim 24, wherein said brand identity in said client comprises said brand identity in said sports team.

26. A restaurant as described in claim 25, wherein said sports team is selected from the group consisting of: an ice hockey team, a baseball team, a football team, a soccer team, a volleyball team, a tennis team, and a basketball team

27. A restaurant as described in claim 26, wherein said ownership in said restaurant alters said scripted thematic content to build brand identity in a sports player of said sports team.

28. A restaurant as described in claim 27, wherein said scripted thematic content perceivable by said restaurant patrons in said dining area of said restaurant comprises a plurality of scripted thematic content.

29. A restaurant as described in claim 28, wherein said dining area located within said second portion of said enclosed space in which restaurant patrons are served said food prepared in said kitchen area comprises a plurality of dining areas, and wherein one each of said dining areas has a corresponding one each of said plurality of scripted thematic content perceived by said restaurant patrons.

30-85. (canceled)
